(19) United States
(12) Patent Application Publication
(10) Pub. No.: US 2026/0359647 A1
(43) Pub. Date: Nov. 12, 2026

(54) Artificial Intelligence Agent Builder Based on Event-Driven Architecture

(71) Applicant: D8AI Inc., Taipei City (TW)

(72) Inventors: Richard Li-Cheng Sheng, Davis, CA (US); Guo-Cheng Lan, Yilan County (TW); Hsieh-Hui Yu, Taoyuan City (TW); Yong-Sheng Wang, Taichung City (TW); Guang-Yau Chen, New Taipei City (TW); Hui Hsiung, Pasadena, CA (US)

(73) Assignee: D8AI Inc., Taipei City (TW)

(21) Appl. No.: 19/204,648

(22) Filed: May 12, 2025

(51) Int. Cl. G06N 3/0895

(52) U.S. Cl. CPC G06N 3/0895

(57) ABSTRACT

An AI agent builder system based on an event-driven architecture for constructing single-agent and multi-agent workflows is disclosed. The system includes an event broker providing message queuing, and service-flow units (SFUs) as workflow building blocks. Each SFU includes an event handler, a flow controller, and a service (large language model, tool, database, or agent). The system implements four built-in flow patterns, i.e., linear, branched, parallel, and looped, that enable construction of complex workflows through a no-code graphical interface. The architecture provides configurable parallel processing capability and a hybrid decision-making mechanism balancing LLM-driven and rule-based approaches. As a pure data-driven solution, workflows can be modified by changing configuration parameters without code changes. The event-driven architecture ensures high reliability, scalability, and maintainability, while substantially reducing development and deployment efforts.

### BACKGROUND OF THE INVENTION

### 1. Field of the Invention

The subject matter disclosed herein relates generally to artificial intelligence (AI), AI agents, chatbots, natural language processing, and workflow or process automation. The present disclosure describes systems and methods of an AI agent builder based on an event-driven architecture.

### 2. Description of the Prior Art

An AI agent is a software application that can interact with its user and its environment and autonomously carry out a specific task. The motivation behind AI agents-process automation, is not new, but the recent popularity of AI agents has been propelled by their leveraging large language models that can make once difficult autonomous tasks approachable. AI agents are expected to perform a wide range of tasks, such as generating sales leads, providing customer supports, optimizing supply chains, conducting market research, making investment decisions, and developing software code. When integrated with hardware, AI agents can find applications in robotics and Internet of Things.

According to a white paper by Google (“Agents”, by J. Wiesinger, P. Marlow, and V. Vuskovic, September 2024), AI agents comprise three main components: an orchestration layer, a large language model (LLM), and tools, as shown in FIG. 1.

With the help of the large language model, the orchestration layer provides planning, reasoning, decision-making, and the process flow of carrying out the agent's task. The tools provide necessary functions that enable the AI agent to interact with the external world (such as accessing and processing data). Depending on their use cases, the degree of autonomy of AI agents can vary substantially (for example, the 6 levels of self-driving cars), requiring various degree of user interventions (known as human in the loop, HITL). In principle, an agent is specialized in a single task, and complex tasks can be carried out via collaboration of multiple agents.

There are a few open-source frameworks or platforms for developing custom AI agents, noticeably LangGraph (by LangChain), AutoGen (by Microsoft), CrewAI (by CrewAI), and Vertex AI Agent Builder (by Google). Essentially, these platforms help software developers to chain sequences of process logic and tool calls for executing a specific task following a user's query.

In addition to using large language models, enterprise-grade AI agents may also need to process a large amount of data with computing-intensive tools, as well as to provide concurrent multi-user operations. Since enterprise computing resources are often limited, the above situations can cause latencies and interruptions at runtime. In other words, enterprise-grade AI agents are likely to encounter scalability and reliability issues.

An effective solution to the above problems is to implement an event-driven architecture in the agentic AI system. However, currently available AI agent builders have yet to provide such architecture fully integrated in their systems.

### SUMMARY OF THE INVENTION

An embodiment provides a method for constructing artificial intelligence (AI) agent workflows. The method comprises orchestrating an event-driven architecture using an event broker that provides a message-queuing mechanism, building an agentic workflow using a plurality of service-flow units (SFUs), wherein each SFU comprises an event handler, a flow controller, and a service that can be a large language model, a software tool, a database, or an AI agent, configuring each event handler as both an event producer and an event consumer that interacts directly with the event broker, implementing each flow controller to provide local flow direction from a current SFU to a subsequent SFU within the agentic workflow, and isolating each service to operate independently from other services in the agentic workflow.

In some aspects, four built-in basic flow patterns are provided for the flow controller to configure: linear, branched, parallel, and looped. The linear flow pattern directs the workflow from a current SFU to a specific subsequent SFU. The branched flow pattern conditionally directs the workflow from a current SFU to one of multiple possible subsequent SFUs according to a result yielded by the service associated with the current SFU. The parallel flow pattern processes multiple sub-flow branches simultaneously, with each sub-flow starting with a current SFU and ending with an aggregator SFU, wherein the aggregator awaits and collects results of all parallel sub-flow branches before moving on. The looped flow pattern repeatedly processes a single sub-flow, with its aggregator collecting the result of each iteration and awaiting completion of the loop before proceeding to a subsequent SFU.

In some aspects, a configurable parallel processing capability can be implemented at the service level or the agent level, enabled by the underlying event-driven architecture.

In some aspects, a no-code, drag-and-drop graphical user interface is provided for constructing complex agentic workflows.

In some aspects, agentic workflows are stored as configuration parameters in a data-driven format, enabling modifications of workflow behavior without code changes.

In some aspects, a hybrid decision-making mechanism provides flexibility in controlling the degree of agentic autonomy. The spectrum ranges from purely rule-based decisions to purely LLM-enabled decisions, with blended approaches in between.

In exemplary implementations, a retrieval-augmented-generation (RAG) system comprising an indexing agent and an inference agent is constructed. The indexing agent processes input documents, classifies them, parses them into text, and converts text segments into semantic vectors. The inference agent handles user queries by converting them into vectors, retrieving relevant text segments through both semantic and keyword-based searching, and using an LLM to generate responses based on the original query and retrieved information.

An embodiment provides an apparatus for constructing artificial intelligence (AI) agent workflows. The apparatus comprises a memory for storing instructions and a processor coupled to the memory. The processor is configured by the instruction to orchestrate an event-driven architecture by implementing an event broker that provides a message-queuing mechanism, build an agentic workflow using a plurality of service-flow units (SFUs), each SFU comprising an event handler, a flow controller, and a service. The processor is further configured to configure each event handler to act as both an event producer and an event consumer that interacts directly with the event broker, implement each flow controller to provide local flow direction from a current SFU to a subsequent SFU within the agentic workflow, and isolate the service to operate independently from other services in the agentic workflow.

An embodiment provides a non-transitory computer-readable storage medium storing instructions. When the instructions are executed by a processor, they cause the processor to orchestrate an event-driven architecture by implementing an event broker that provides a message-queuing mechanism, build an agentic workflow using a plurality of service-flow units (SFUs), wherein each SFU comprises an event handler, a flow controller, and a service, configure each event handler to act as both an event producer and an event consumer that interacts directly with the event broker, implement each flow controller to provide local flow direction from a current SFU to a subsequent SFU within the agentic workflow, and isolate the service to operate independently from other services in the agentic workflow.

To the accomplishment of the foregoing and related ends, certain embodiments comprise the features hereinafter fully described and particularly pointed out in the claims. The following description and accompanying drawings set forth in detail certain illustrative aspects of the embodiments. These aspects are indicative, however, of but a few of the various ways in which the principles of the embodiments may be employed, and the present disclosure is intended to include all such aspects and their equivalents. These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram illustrating the main components of AI agents according to the prior art.

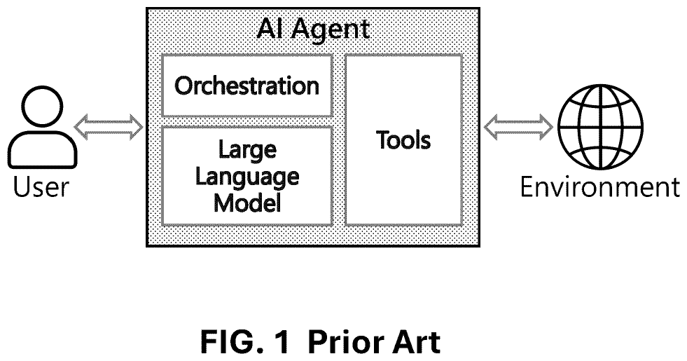

FIG. 2 is a block diagram depicting a general event-driven architecture consistent with the embodiments.

FIG. 3 is a block diagram illustrating the main components of the AI agent builder according to the embodiments.

FIG. 4 is a detailed architecture diagram of a single agent builder according to the embodiments.

FIG. 5 is a diagram illustrating the four basic event flow patterns built into the service-flow engine according to the embodiments.

FIG. 6 is an architecture diagram illustrating a multi-agent builder according to the embodiments.

FIG. 7 is an illustration of the user interface according to the embodiments.

FIG. 8 is a block diagram illustrating the main components of an AI chatbot builder associated with the AI agent builder according to the embodiments.

FIG. 9 is a block diagram illustrating a RAG process implemented with collaborating agents according to the embodiments.

### DETAILED DESCRIPTION

The present disclosure is aimed at addressing the above-described issues with a detailed description of various embodiments. While specific implementation details are presented herein to facilitate a comprehensive understanding of the disclosure, it will be apparent to those skilled in the art that the present invention may be realized without necessarily adhering to all such particularities. In certain instances, well-established methods, procedures, and components have been omitted from exhaustive description to avoid obscuring the present disclosure. It should be understood that technical features individually described in relation to a single drawing may be implemented either discretely or in combination with other features, as set forth in the present specification.

### 1. Event-Driven Architecture

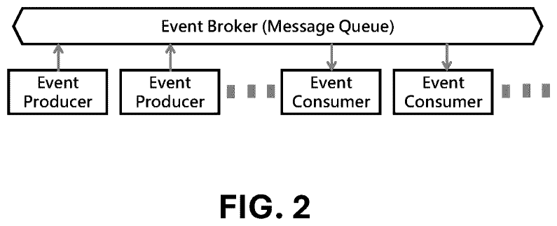

The event-driven architecture is a software design based on three key components: event producers, event consumers, and an event broker, as depicted in FIG. 2. An event producer can generate an event (for example, a user query being submitted), and one or more event consumers listening to such an event will receive it and react accordingly. The event broker is the mechanism that orchestrates the event transportation from event producers to event consumers. All producers and consumers are independent of one another, and their executions are asynchronous.

This independence means that each component (event producer or event consumer) can operate without direct knowledge of or coupling to other components in the system. The components can communicate through the standardized event messages passed via the event broker. The asynchronous execution ensures that the components can proceed with their operations concurrently under the coordination of the event broker, thereby preventing blocking behavior that could create bottlenecks in the system. This decoupling and asynchronous processing are critical for enterprise-scale applications where different components may have varying processing speeds or resource requirements, enabling the system to maintain optimal performance even under fluctuating loads.

Normally an event carries a message that contains a payload (the main data content to be processed) and metadata (information about the message). The event broker provides a message queue that acts as a buffer where the message is held until the consumer is ready to process it.

The event-driven architecture is a loosely coupled architecture, making it flexible to customize and scale and easy to maintain. The data buffering provided by the message queue further makes such a system more robust at runtime. To date, Apache Kafka and RabbitMQ are two most popular open-source event brokers.

In the context of AI agent development, this event-driven approach offers significant advantages over traditional monolithic architectures. When processing intensive AI tasks such as large language model inferences or complex data transformations, the decoupling of components prevents performance degradation across the entire system. Additionally, the message queue mechanism enables graceful handling of traffic spikes and provides inherent fault tolerance—if a consumer fails, messages remain in the queue and can be processed once the consumer recovers or is replaced. This resilience is particularly crucial for enterprise AI applications where service continuity and reliable operation are paramount. Furthermore, the architecture's loose coupling facilitates independent modification and deployment of services, allowing for incremental updates and innovations without disrupting the overall system.

### 2. Event-Driven AI Agent Builder

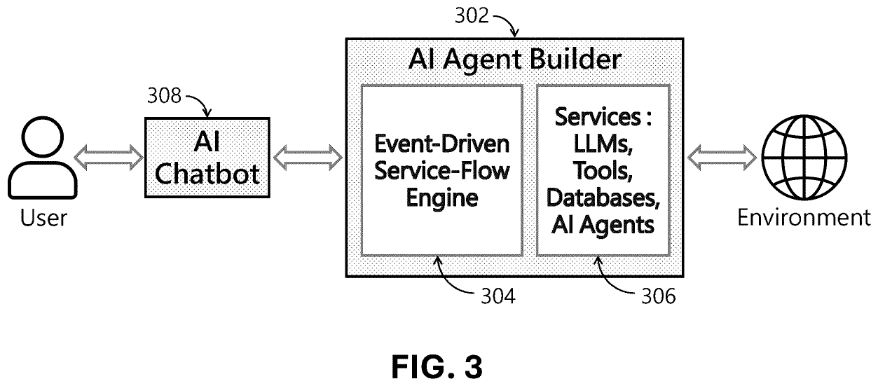

FIG. 3 depicts a high-level view of the AI agent builder 302 of the present invention, where a “service-flow engine” 304 based on an event-driven architecture makes up the core of the orchestration layer, and services 306 connected to the service-flow engine can be large language models (LLMs), tools, databases needed for the agent's task, or other pre-built AI agents. Optionally, an AI chatbot 308 can be incorporated to serve as a conversational user interface for the user to communicate with the AI agent. Essentially it facilitates human-in-the-loop implementation of AI agents.

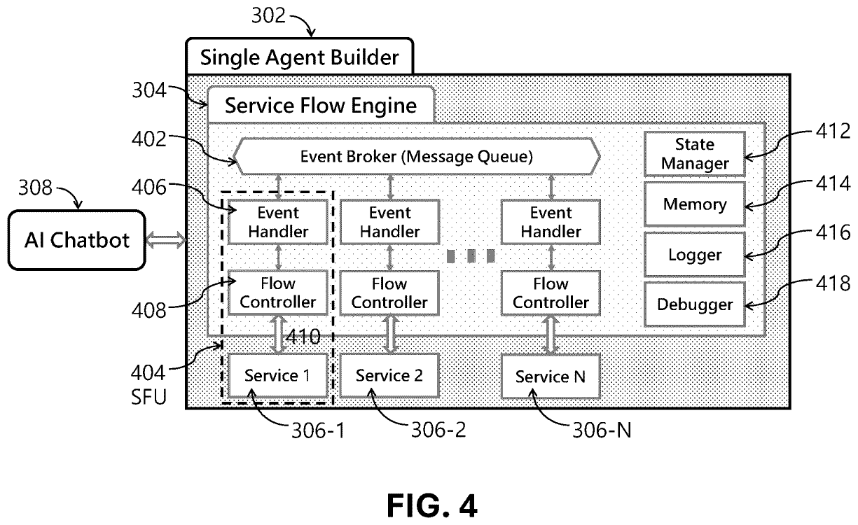

The architecture of the service-flow engine 304 is shown in FIG. 4. The event-driven architecture is orchestrated by an event broker 402 that provides a message-queuing mechanism. The building block of the agentic workflow—“service-flow unit (SFU)” 404, comprises an event handler 406, a flow controller 408, and a service 306 (also known as microservice). Notice that the service 306 is connected to but not included in the service-flow engine 304.

Each event handler 406 can act both as an event producer and as an event consumer, interacting directly with the event broker 402. The flow controller 408 provides the local flow direction from the current SFU (event producer) to the next SFU (event consumer). Notice that in FIG. 4, there is no implied sequence among the SFUs. The actual executing sequence of the SFUs is determined by configurations of individual flow controllers 408 according to the specific task of an agentic workflow. The service 306 associated with each SFU can be a large language model, a tool, a database, or a pre-built AI agent. Through an application-programming-interface (API) connection 410 to the service-flow engine 304, a service can be cloud-based or local. Certain embodiments of the API connection 410 can encompass the Model Context Protocol (MCP) standard, which has been gaining popularity for AI applications.

All services are independent of one another. The independence described here is a fundamental design principle that ensures each service can be developed, maintained, and scaled separately without affecting other components in the system. The large language model services can handle natural language understanding and generation tasks, producing text outputs based on prompts derived from user queries or system-generated data. These LLMs can be selected based on specific requirements for reasoning capabilities, domain expertise, or inference speed. Tool services represent functional components that perform specific operations such as data manipulations, mathematical calculations, document processing tasks, or external API calls. These tools extend the agent's capabilities beyond natural language processing, enabling practical interactions with external systems and data sources. Database services provide persistent storage and retrieval capabilities, allowing the agent to maintain context, store intermediate results, and access reference information throughout the workflow execution.

Practical implementation of the service-flow engine 304 require a state manager 412 for keeping track of the status of all events and flows during runtime, as well as a memory unit 414 for storing both long-term and temporary data used by the agentic workflow. To facilitate debugging of agentic workflows, certain embodiments further include a logger 416 that keeps time-stamped records of the entire process history for each running session. Furthermore, a debugger unit 418 can be included that provides step-by-step diagnosis of the event-driven agentic workflow.

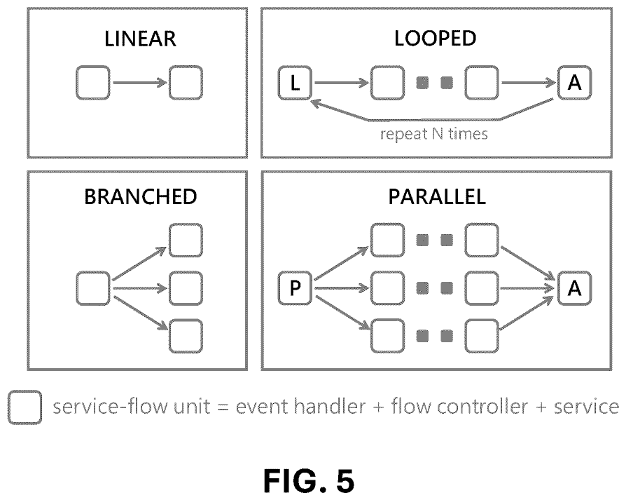

There are four built-in basic flow patterns for the flow controller to configure: “Linear”, “Branched” (conditionally), “Parallel”, and “Looped”, as shown in FIG. 5. Agentic workflows, no matter how complex, can in principle be constructed using combinations of these basic flow patterns. The Linear flow pattern directs the workflow from a current SFU to a specific subsequent SFU. The Branched flow pattern conditionally directs the workflow from a current SFU to one of multiple possible subsequent SFUs according to a result yielded by the service associated with the current SFU. The Parallel flow pattern processes two or more branches of sub-flows (i.e., parts of a workflow) in parallel, with each sub-flow starting with a current SFU and ending with an aggregator SFU, wherein the aggregator awaits and collects results of all parallel sub-flow branches before moving on to a subsequent SFU. The Looped flow pattern repeatedly processes a single sub-flow starting with a current SFU and ending with an aggregator SFU, wherein the aggregator collects the result of each sub-flow iteration and awaits the completion of the loop-according to either a fixed number of repeats provided by incoming data or a loop-ending condition determined dynamically during runtime.

It should be noted that the aggregator represents a specialized type of service-flow unit (SFU) that serves as a collection and integration point within Parallel and Looped flow patterns. In Parallel flows, the aggregator waits for all parallel branches to complete their execution before proceeding, ensuring that all necessary results are available for subsequent processing. This synchronization point prevents race conditions and data inconsistencies that might occur if the workflow continued with only partial results. In Looped flows, the aggregator collects results from each iteration, accumulating them while evaluating loop termination conditions to determine when the iterative process should conclude. The aggregator essentially brings multiple asynchronous operations back into a synchronized state, maintaining data integrity while preserving the performance benefits of parallel and iterative processing. It represents a critical control mechanism that provides deterministic behavior within the otherwise asynchronous event-driven architecture.

To illustrate the practical applications of these flow patterns, consider a travel booking service implemented as an AI agent. In a Linear flow pattern, the agent might sequentially process steps such as collecting the user's travel preferences, searching available flights, displaying options, processing payment information, and issuing tickets—each step immediately following the previous one. A Branched flow pattern could be employed when the agent needs to make routing decisions based on search results; for instance, if no direct flights are available, the workflow branches to a connection flight search path, while available direct flights trigger a different processing path focusing on carrier comparisons. The Parallel flow pattern proves valuable when the agent simultaneously searches multiple travel providers' databases for flight, hotel, and car rental options, with the aggregator SFU collecting all results, eliminating duplicates, and ranking them according to user preferences before presenting the consolidated options. The Looped flow pattern might be utilized for monitoring ticket prices over time; the agent repeatedly checks pricing at scheduled intervals until either a fare satisfying the user's target price is found or the user's deadline is reached, with the price trend updated and possibly the search parameters adjusted after each iteration. These basic flow patterns can be combined to create sophisticated workflows—for example, a travel-package booking agent can use parallel searches for multiple databases, coupled with conditional branches based on availability, followed by an iterative search for an optimum combination until a package meeting customer criteria is found.

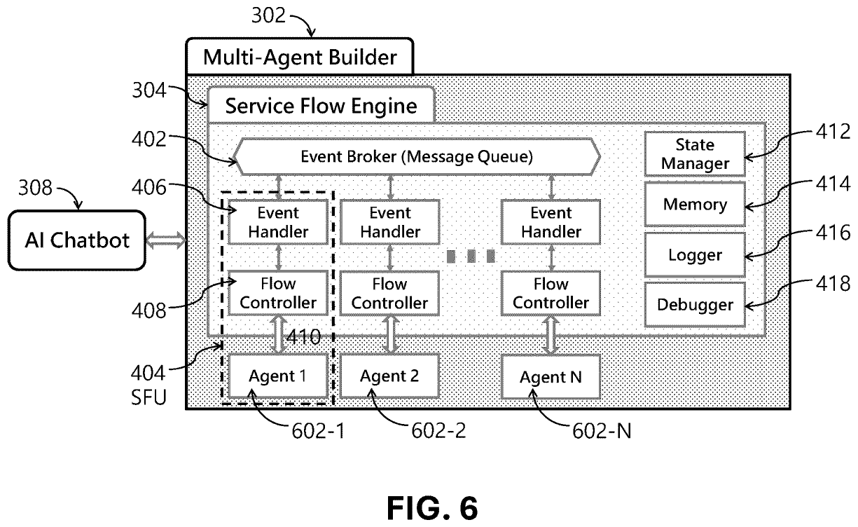

Using the AI agent builder of the present invention, agentic workflows involving multi-agents can be built. FIG. 6 depicts the construction of a master agent 302 that comprises a crew of independent, asynchronously linked pre-built agents 602-1 to 602-N.

The similarities between FIG. 6 (multi-agent builder) and FIG. 4 (single agent builder) highlight the recursive nature of the design philosophy. Both embodiments employ the same service-flow engine 304 with its underlying event-driven architecture, including the event broker 402, the event handlers 406, the flow controllers 408, the state manager 412, the memory unit 414, the logger 416 and the debugger 418. That is, the service-flow engine 304 of both embodiments are implemented with an identical set of software code.

The difference between the two embodiments is in the granularity and complexity of the services being orchestrated by the service-flow engine. In the single agent builder (FIG. 4), the service-flow engine 304 coordinates relatively simple services (306-1 to 306-N), such as LLMs, tools, and databases. In contrast, in the multi-agent builder (FIG. 6), the service-flow engine 304 coordinates an entire crew of pre-built agents (602-1 to 602-N), each containing its own complete internal workflow built with the single agent builder (FIG. 4). Other embodiments representing a hybrid of the above two can be implemented, wherein a combination of simple services and agents are orchestrated by the service-flow engine.

The multi-agent architecture represents a higher level of abstraction and complexity compared to the single agent structure, enabling the system to tackle intricate enterprise challenges through collaboration of specialized agents. Each member of the agent crew operates as a complete agent with its own internal workflow, expertise, and functionality, yet collectively they function as components within the overarching master agent's workflow. This hierarchical design enables sophisticated division of labor, where complex problems can be decomposed into manageable sub-problems assigned to specialized agents—similar to how an enterprise distributes responsibilities among departments with different expertise. The master agent orchestrates this collaboration by routing information, coordinating parallel execution, and synthesizing results from its constituent agents, thus creating an emergent intelligence greater than the sum of its parts. For example, a master flight ticketing agent may comprise a flight search agent, responsible for interfacing with multiple airline reservation systems, and a ticket purchasing agent for processing transactions. The flight search agent would have its own complete workflow optimized for efficiently querying diverse flight databases, comparing schedules, analyzing routing options, and filtering results based on user preferences. It may implement specialized services for parsing airline-specific data formats, normalizing flight information across carriers, calculating layover durations, and estimating on-time performance based on historical data. The flight search agent would operate independently, receiving search criteria from the master agent and asynchronously returning comprehensive flight options without blocking operations of the ticket purchasing agent. On the other hand, the ticket purchasing agent would handle the complex workflow of reservation holds, payment processing, fee calculations, and ticket issuance. It may implement specialized services for securely managing payment information, validating fare rules, applying promotional codes, processing refunds, and generating booking confirmations. The ticket purchasing agent can interface with payment gateways and ticketing systems independently of the flight search agent, allowing it to complete transactions efficiently once the user selects a flight option.

### 3. No-Code and Data-Driven Implementation

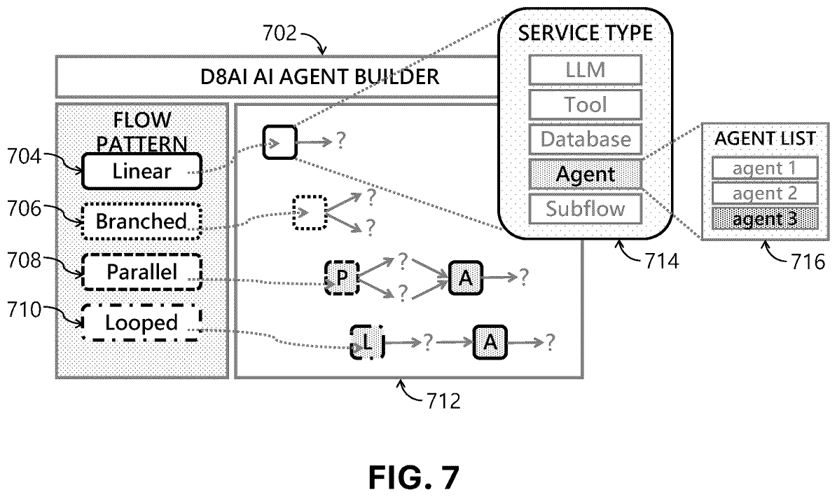

A no-code user interface 702 is provided to implement the event-driven agent builder of the present invention, as illustrated in FIG. 7. An agentic workflow is constructed as a graph comprising nodes (blocks) and edges (arrowed lines), wherein each node represents a service-flow unit (SFU), with connecting directional edges indicating the flow directions.

With this user interface, an agentic workflow is constructed with the following steps:
(1) Create individual SFU nodes by dragging and dropping one of the 4 basic flow patterns 704, 706, 708, and 710 into the work area 712. This step defines the flow controller of each SFU. For the Parallel 708 and Looped 710 flow patterns, two SFU nodes are generated simultaneously-one as the current node and the other as the aggregator node (labeled “A”). Nodes can be inserted in parallel between the Parallel node (labeled “P”) and its aggregator, and nodes can be inserted in series between the Looped node (labeled “L”) and its aggregator. The aggregator node (a Linear node by default) collects the results and ends the parallel or iterative operation.
(2) Click on each SFU node and select its service type 714: LLM, tool, database, agent, or sub-flow (a pre-built, reusable flow segment without an API endpoint), and then use a drop-down list 716 to select a pre-built service of the selected type.
(3) Connect all SFU nodes with directional edges to complete the workflow. The connection rules are built in according to the flow patterns.
(4) Save the agentic workflow for further use.

Although the resulting workflow graph may look similar to that produced by other graphical builders of agents (for example, LangGraph), the underneath architecture here is fundamentally different from other agent builders, as explained below.

In the embodiments of the present invention, agentic workflow graphs can be fully integrated with the event-driven architecture described above, and consequently all timing issues are automatically taken care of. For example, the aggregator of a Parallel flow will wait for all parallel branches of operation to complete before proceeding to the next operation.

The AI agent builder of the present invention is a pure data-driven solution. That is, an agentic workflow generated by it can be modified by simply changing configuration parameters without code changes. This capability of dynamic modifications at runtime substantially reduces the efforts needed in development, testing, and deployment of AI agents.

The data-driven capability of the embodiments is implemented as follows. The event-driven service-flow engine 304 is implemented with a set of software code. This code is universal for AI agents built with the embodiments of the present invention, and it only needs to be deployed once for a particular production environment. Simple services 306, such as LLMs, tools and databases, each implemented with their own independent code, are called by the service-flow engine during runtime according to agentic tasks. The services can be deployed on premises or in the cloud. The no-code user interface 702 is used during an AI agent's development stage, and as a result, each agentic workflow is recorded as a configuration data file that can be interpreted by the service-flow engine. Therefore, AI agentic workflows, no matter how complex, can be deployed and executed as data.

### 4. Parallel Processing Capability

In addition to the Parallel flow pattern, the AI agent builder of the present invention further provides a configurable parallel processing capability. This capability can be implemented at the service level or the agent level. That is, if any of the services becomes a bottleneck of the agentic system, it can be configured to run in parallel over a preset number of channels. Similarly, if the overall computing efficiency needs to be boosted, the entire agentic system can run in parallel over multiple channels. Such a parallel processing capability is enabled by the underlying event-driven architecture.

To illustrate, consider the flight ticketing agent described earlier. If one of the constituent services-say, payment processing, experiences a long latency and becomes a bottleneck, multiple, parallel channels of payment processing can be configured to distribute the traffic at the service level. On the other hand, if a large number of incoming queries are encountered, multiple channels of the flight ticketing agent can be configured to digest the heavy traffic at the agent level.

The event-driven architecture makes this parallelization straightforward to implement and manage. When a service or agent is configured for parallel processing, the event broker automatically handles the complexity of distributing events, tracking progress across multiple channels, and aggregating results without requiring developers to write additional code. This capability provides substantial performance benefits without increasing system complexity, allowing enterprise deployments to scale efficiently to meet demand fluctuations while maximizing hardware utilization

### 5. Hybrid Decision-Making Mechanism

In an ideal use case of AI agent, a large language model (LLM) plays the role of a fully autonomous brain that can process planning, reasoning, and decision-making. However, in real use cases of an enterprise environment, agentic workflows are complex, and their decisions are critical. An LLM is prone to hallucinations and making mistakes, and hence it is risky to rely on an LLM to make decisions by itself. Furthermore, most enterprise workflows follow standard operating procedures and hence they are rule-based.

The agent builder of the embodiments of present invention provides a hybrid decision-making mechanism. On one hand, the service-flow engine can support a structured, deterministic work process, including making decisions (for example, in conditional Branched flows). On the other hand, an LLM connected to the service-flow engine as a service, can be called anytime to generate content or make non-critical, probabilistic decisions. This hybrid mechanism enables the flexibility of controlling the degree of agentic autonomy according to different requirements for each use case.

The hybrid decision-making architecture can offer a spectrum of decision modes that can be implemented at different points within the same workflow based on the nature and criticality of each decision. At one end of the spectrum, fully rule-based decisions follow explicit, predetermined logic paths defined by business rules and operational constraints. These deterministic decisions are ideal for scenarios with clear compliance requirements, established protocols, or mission-critical processes where predictability and consistency are paramount. For instance, in a financial services AI agent, approval of transactions exceeding certain thresholds would follow strict rule-based criteria rather than probabilistic assessments.

In the middle of the spectrum is a blended approach where LLM-generated recommendations are filtered through rule-based validation gates. This type of implementation uses the LLM's ability to consider numerous factors and generate creative solutions while maintaining guardrails through explicit business rules. For example, in a product recommendation agent, the LLM might generate personalized suggestions based on customer preferences and behavior patterns, but rule-based filters would ensure these recommendations only include in-stock items, appropriately priced options, and products that comply with local regulatory requirements.

At the other end of the spectrum, fully LLM-driven decisions can be deployed for scenarios requiring complex contextual understanding, nuanced interpretations, or creative solutions where the consequences of suboptimal decisions are manageable. Content generation, conversation handling, and exploratory analysis typically fall into this category. For example, a travel booking agent might use fully LLM-driven decision-making when generating personalized itinerary suggestions and travel tips, where creativity and personalization add value without significant downside risks.

The AI agent builder facilitates this hybrid approach through its loosely-coupled modular architecture. Developers can insert validation checkpoints between LLM-driven services to enforce business rules, implement approval schemes for decisions exceeding confidence thresholds, or configure automatic escalation to human operators for edge cases. This flexibility allows organizations to precisely calibrate the autonomy level of each decision point based on its business impact, regulatory requirements, and confidence in the LLM's capabilities for the specific task.

The optional AI chatbot connected to the AI agent can provide an effective communication channel between the user and the agent. It allows the user to participate in the decision-making process and further ensures the reliability of the agent. This human-in-the-loop capability can be selectively engaged at critical decision points, providing an additional layer of oversight and expertise when needed without requiring constant human supervision for routine operations.

### 6. AI Chatbot Builder

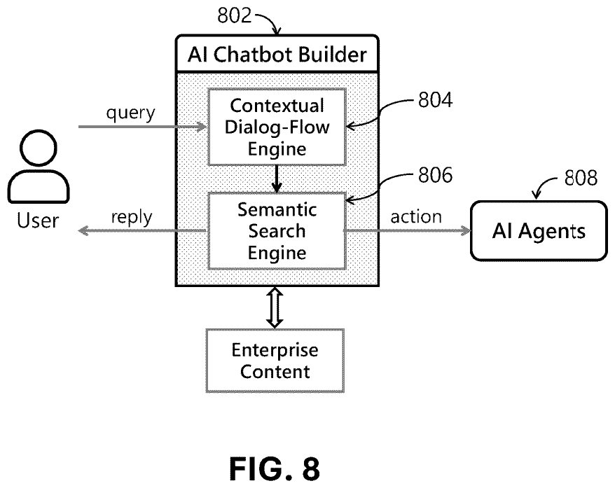

The optional AI chatbot 308 can be built using an AI chatbot builder 802. As shown in FIG. 8, it comprises two main components: a contextual dialog-flow engine 804 and a semantic search engine 806.

The contextual dialog-flow engine 804 is for constructing complex rule-based conversational flows commonly included in enterprise workflows. An intuitive drag-and-drop-style graphic user interface for building flow graphs of nodes and edges is provided. Unlike the user interface of the computing-intensive AI agent builder, the event-driven architecture is unnecessary here.

The semantic search engine 806 is based on a BERT (Bidirectional Encoder Representations from Transformers) language model or its derivative for understanding the user query and finding a correct response to it-either providing a textual reply or sending an action instruction to the AI agent 808. The BERT language model employs a “bidirectional attention” mechanism that extracts the contextual meaning of a word via its relations to other words both preceding and following it. This enables BERT to develop a rich contextual understanding of human languages. In the context of the semantic search engine, the BERT model transforms natural language queries into high-dimensional vector representations (known as “embeddings”) that capture the semantic meaning beyond keyword matching. The semantic embeddings encode intents, as well as contextual nuances, of queries, allowing the system to match a user request with an appropriate response even when there is no exact literal overlap between the two.

The search engine maintains a vector database of potential responses or actions, each similarly encoded into the same vector representation. When a user query is received, it computes semantic similarity between the query vector and all potential response vectors using metrics such as cosine similarity. This approach enables the engine to recognize semantic equivalence between differently worded but conceptually identical queries (such as “book a flight” and “purchase an airline ticket”), and hence significantly improves the accuracy and flexibility of the conversational interface. Advanced implementations may incorporate domain-specific fine-tuning of the BERT model to better recognize industry terminology, enterprise-specific vocabularies, or specialized user intents relevant to the AI chatbot's purpose, further enhancing the precision of semantic matching without requiring exhaustive enumeration of all possible query variations.

The AI chatbot builder can be linked to enterprise-specific content, for example, enterprise resource planning (ERP), customer relationship management (CRM), human resources information, and other corporate data repositories through secure API connections. Such integration allows AI agents to access private business data, enforce role-based security controls, and align with established organizational workflows.

Furthermore, in a multi-agent system, the AI chatbot can be used as an agent router for the user to selectively activate an individual agent.

### 7. Example: Building a Retrieval-Augmented-Generation (RAG) Agent

Nearly all modern language models are based on the transformer deep neural networks published by Google in 2017. In a transformer model, words are converted into semantic vectors (known as “word embeddings”), and contextual relationships among words are extracted by a mechanism named “attention”. The original transformer model comprises an encoder network and a decoder network. Either the encoder or the decoder can function as a stand-alone deep-learning model. For example, BERT, the best-known transformer encoder, can provide very good contextual and semantic understanding of human languages. And GPT-3.5, the base model of ChatGPT, is a transformer decoder that became the first widely successful generative large language model.

It is well known that in response to a user query, a large language model could hallucinate or provide irrelevant information. Retrieval-augmented generation (RAG) is a method that can improve the accuracy and relevancy of the LLM's response by augmenting the user query with additional information retrieved from a specific knowledge source of interest. In other words, the RAG approach enhances LLM outputs by focusing them on specific knowledge sources.

In the following, constructing a RAG agent is used to illustrate the implementation of the AI agent builder of the present invention. The implementation of RAG as two collaborating agents, i.e., “Indexing” and “Inference”, shows the AI agent builder's ability to separate concerns while maintaining operational cohesion.

The RAG method comprises 3 main steps:
(1) Indexing: First, textual content is extracted from source documents (the knowledge base) and broken down into text chunks (for example, with no more than 1,024 tokens per chunk). The text chunks are then converted into semantic vectors using a natural-language-understanding model such as BERT. This embedding process transforms the linguistic content into high-dimensional (typically 768 or 1,024 dimensions) numerical vector representations that capture semantic meaning beyond words. The resulting vectors are stored in a vector database. The vector database may employ indexing techniques, such as Inverted File (IVF) and Hierarchical Navigable Small World (HNSW), to enable efficient large-scale vector search in the following step.
(2) Search: When the user submits a query, it is converted into a semantic vector using the same language model for indexing, and then the vector database is searched and text chunks that have high semantic similarity to the query are retrieved. The vector-based search makes this process highly efficient. The semantic similarity is typically measured using metrics such as cosine similarity. The semantic search is capable of identifying conceptually relevant information even when there is minimal literal overlap between the user query and source documents. More sophisticated implementations may employ hybrid retrieval approaches, combining semantic search with traditional keyword matching, followed by re-ranking of the combined search results using the same vector-similarity metrics.
(3) Inference: Immediately following the search step, the textual forms of the user query and the retrieved text chunks are combined and fed into the LLM to generate a response. This combination process, often called “prompt engineering”, structures the information in a way that guides the LLM to use the retrieved context when formulating its response. The prompt typically includes explicit instructions for the LLM to base its answers on the provided information, acknowledge when information is not available in the retrieved chunks, and maintain the style and tone appropriate for the application domain. The LLM then generates a contextually relevant response that integrates information from multiple retrieved text chunks while maintaining a natural language flow. This approach significantly reduces hallucinations compared to using the LLM alone.

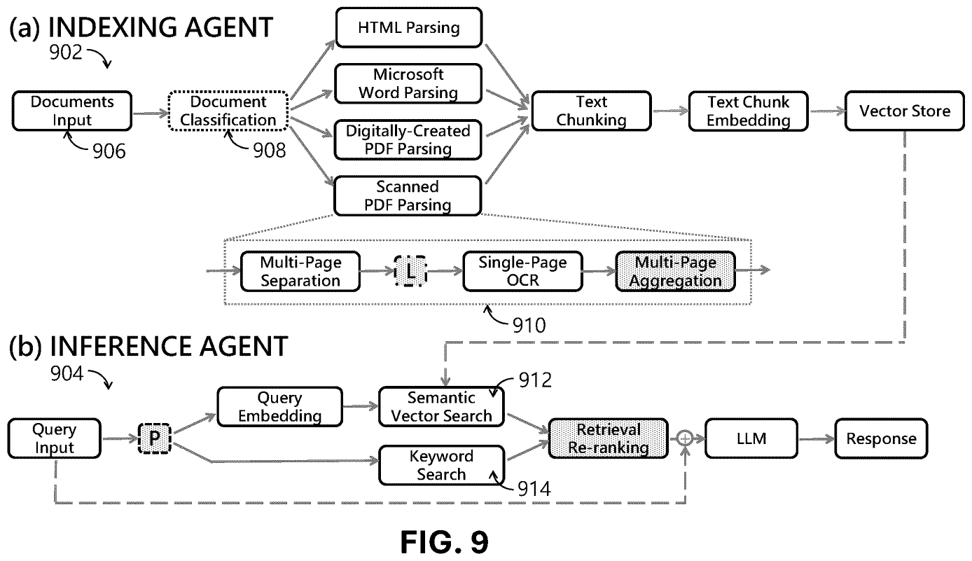

Since the search and inference steps are consecutive, they can be combined into an end-to-end process. Therefore, an autonomous RAG process can be implemented with two agentic workflows-Indexing agent 902 and Inference agent 904, as shown in FIG. 9.

In the Indexing agentic workflow 902, input documents 906 are parsed to extract their textual content for subsequent chunking and embedding. The document classification 908 (a Branched node) is used to determine the file type of each document and then route it to an adequate parsing path.

The Looped event-driven operation is illustrated with the scanned PDF parser 910. Here, a deep-learning OCR model is used to extract textual content of single-page images. A multi-page scanned PDF file is first separated into single-page images, and then the images are fed into the OCR processing loop. To boost the efficiency of this potentially long-latency process, the AI agent builder of the present invention supports batched parallel processing during each iterative cycle (i.e., multiple images can be processed simultaneously).

Notice that in FIG. 9, a Looped or Parallel flow has a beginning node (labeled “L” or “P” respectively) and an ending aggregator node (shaded). The beginning node (containing an event handler and a flow controller but no service) is there for directing the flow traffic without calling a service.

In the Inference agentic workflow 904, two searches are conducted in parallel in response to each user query. In addition to the semantic vector search 912 described earlier, a conventional keyword-based search 914 is implemented for enhancing the overall search performance. Each search results in a ranked retrieval list, and the two lists are then combined and re-ranked, yielding a final ranked retrieval list. The latter is combined with the user query for prompting the LLM.

In other words, within the Indexing agent 902, the process begins with Documents Input 906, which serves as the entry point for various types of documents that will form the knowledge base. These documents flow to the Document Classification 908, a Branched node (indicated by its dotted boundary) that analyzes each document's file type and routes it to the appropriate specialized parser. One such parser is the Scanned PDF Parser 910, implemented as a Looped node (marked with “L” and dashed-dotted boundary) that handles image-based PDFs requiring optical character recognition (OCR). This parser demonstrates the system's efficiency optimization by separating multi-page PDFs into individual images and batch-processing them through parallel OCR channels. Other specialized parsers (not explicitly labeled but implied) handle different formats of documents, extracting their textual content accordingly. After extraction, the text passes through a chunking process that breaks textual content into manageable text segments of appropriate sizes for embedding, balancing context preservation with database optimization. These chunks then flow to a text embedding service that converts them into semantic vectors using a natural language understanding model, creating numerical vector representations that capture the semantic meaning of each chunk. Finally, these vectors are stored in a vector database, indexed for efficient similarity search while maintaining references to their source text.

The Inference agent 904 is activated when a user submits a query. Two search processes then occur simultaneously: the Semantic Vector Search 912 converts the query into a vector and performs similarity matching against the stored document vectors, while the Keyword-Based Search 914 conducts traditional literal matching in parallel. This dual approach exemplifies the Parallel flow pattern, running two complementary search strategies simultaneously to overcome the limitations of either method alone. The results from both searches flow to a retrieval re-ranking node that combines, rescores, and consolidates the findings into a final ranked list of the most relevant text chunks. These retrieved chunks are then combined with the original user query to construct a prompt for the large language model, which generates a natural language response based on the specific knowledge contained in the retrieved information.

### 8. Conclusion

In summary, the various embodiments described above demonstrate the fundamental distinctions between the AI agent builder of the present invention and existing art. The AI agent builder of the present invention has integrated event-driven and data-driven architecture, which directly addresses the critical challenges of scalability and reliability that enterprise-grade AI agents face. By implementing a message-queuing mechanism through the event broker, the system effectively handles latency issues, computing resource constraints, and concurrent multi-user operations that commonly plague enterprise deployments. The service-flow unit (SFU) concept, combining event handlers, flow controllers, and services within an asynchronous framework, enables sophisticated workflow orchestration without the tight coupling that traditionally limits system flexibility and maintainability. Furthermore, the pure data-driven approach allows for dynamic runtime modifications through simple configuration parameter changes, eliminating the need for code alterations and dramatically streamlining the development-testing-deployment cycle.

This architectural approach represents a paradigm shift in how AI agent systems are constructed and operated in enterprise environments. While existing frameworks have made strides in agent development, they fundamentally lack the resilience and adaptability required for mission-critical business applications. The event-driven architecture decouples processing components in both time and space, temporally allowing operations to proceed at their own optimal pace without blocking other processes, and spatially allowing components to be distributed across computing resources as needed. This decoupling creates inherent fault tolerance, as the failure of individual components doesn't cascade through the system, and it enables graceful degradation rather than catastrophic failure when under stress.

The hybrid decision-making mechanism further distinguishes this invention by acknowledging the practical reality that enterprise systems require a balance between LLM-driven intelligence and rule-based guardrails. This balanced approach allows organizations to leverage the creative problem-solving capabilities of large language models while maintaining precise control over critical decision points, creating AI agents that can be trusted with consequential business operations. The no-code graphical interface, with its intuitive flow patterns and drag-and-drop functionality, democratizes agent development beyond specialized AI engineers to domain experts who can directly translate their business process knowledge into functional agent workflows.

The paralleled processing capabilities at both service and agent levels ensure that the architecture can scale efficiently with demand, optimizing resource utilization and maintaining consistent performance under varying loads. By embedding this capability directly into the architecture rather than requiring custom implementations, the invention eliminates a significant engineering burden typically associated with high-performance AI systems. This combination of event-driven communication, modular composition, configuration-based adaptation, and inherent parallelization creates an agent building system that not only performs more reliably under enterprise conditions but also significantly reduces the engineering effort required to create, maintain, and evolve complex AI agent solutions in production environments, ultimately enabling organizations to deploy sophisticated AI automation at scale with confidence in its operational resilience.

### 9. Additional Notes

The systems described herein may be implemented across various computing architectures including, but not limited to, central processing units (CPUs), graphical processing units (GPUs), tensor processing units (TPUs), specialized neural processing units (NPUs), application specific integrated circuits (ASICs), or field programmable gate arrays (FPGAs). These systems may execute on distributed networks, cloud computing environments, edge devices, or any combination thereof. The components may be implemented in hardware, firmware, software, or any combination thereof.

Data protection measures may be implemented to protect user privacy, which may include anonymization of collected information, provision for opt-in/opt-out of data collection programs, and generalization of user interaction data. In certain implementations, such measures may extend to federated learning, differential privacy, or other privacy-preserving techniques.

The operational steps described may be performed in different sequences, and steps may be combined or separated. The drawings are illustrative and not to scale. The embodiments may incorporate additional features compatible with the core invention, or selectively omit non-essential elements, allowing flexible implementations for specific applications while remaining within the scope of the invention.

While the invention has been described in connection with certain embodiments, it will be understood by those skilled in the art that various modifications and adaptations can be made without departing from the scope of the invention. The specific embodiments presented are intended to illustrate the invention and not to limit its application or construction. Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for constructing artificial intelligence (AI) agent workflows, comprising:
orchestrating an event-driven architecture using an event broker that provides a message-queuing mechanism;
building an agentic workflow using a plurality of service-flow units (SFUs), wherein each SFU comprises an event handler, a flow controller, and a service comprising a large language model, a software tool, a database, or an AI agent;
configuring each event handler as both an event producer and an event consumer that interacts directly with the event broker;
implementing each flow controller to provide local flow direction from a current SFU to a subsequent SFU within the agentic workflow; and
isolating each service to operate independently from other services in the agentic workflow.

2. The method of claim 1, further comprising:
managing states of the AI agent workflows during runtime using a state manager.

3. The method of claim 1, further comprising:
storing long-term data and temporary data used in the AI agent workflows in a memory unit.

4. The method of claim 1, further comprising:
deploying each service on either a cloud-based server or a local server; and
establishing communication between each service and its associated SFU through an application programming interface (API).

5. The method of claim 1, wherein the AI agent workflows are constructed using basic flow patterns as building blocks, comprising:
a linear flow pattern implemented by a flow controller that directs the workflow from a current SFU to a specific subsequent SFU;
a branched flow pattern implemented by a flow controller that conditionally directs the workflow from a current SFU to one of multiple possible subsequent SFUs according to a result yielded by the service associated with the current SFU;
a parallel flow pattern implemented by a flow controller that processes multiple sub-flow branches simultaneously, with each sub-flow starting with a current SFU and ending with an aggregator SFU, wherein the aggregator awaits and collects results of all parallel sub-flow branches before moving on to a subsequent SFU; and
a looped flow pattern implemented by a flow controller that repeatedly processes a single sub-flow starting with a current SFU and ending with an aggregator SFU, wherein the aggregator collects results of each iteration of the sub-flow and awaits completion of the loop before moving on to a subsequent SFU.

6. The method of claim 1, further comprising:
providing a graphical user interface for visually constructing the agentic workflows, wherein the graphical user interface displays nodes representing service-flow units (SFUs) and arrowed edges representing flow directions between SFUs.

7. The method of claim 6, further comprising:
enabling drag-and-drop creation of SFU nodes by selecting from predefined flow patterns comprising linear, branched, parallel, and looped patterns; and
enabling selection of service types and specific services for each SFU node through menus in the graphical user interface.

8. The method of claim 6, further comprising:
storing the graphically constructed agentic workflows as configuration parameters in a data-driven format that enables modification of workflow behavior without code changes.

9. The method of claim 1, further comprising:
parallel processing at the service level, wherein a service is processed simultaneously over configurable multiple channels; and
parallel processing at the agent level, wherein an agentic workflow is processed simultaneously over configurable multiple channels.

10. The method of claim 1, wherein the AI agent workflows comprise an AI chatbot configured as a conversational user interface for human to interact with the AI agent.

11. The method of claim 1, further comprising:
constructing a retrieval-augmented-generation (RAG) system using the agentic workflows, wherein the RAG system generates responses to user queries based on retrieved textual content from input documents.

12. The method of claim 11, further comprising:
implementing an indexing agent within the RAG system for processing input documents, wherein the indexing agent performs:
classifying types of the input documents;
parsing documents of different types into a textual format;
breaking textual content of the parsed documents into text segments;
converting each text segment into a semantic vector; and
storing the semantic vectors into a vector database.

13. The method of claim 12, further comprising:
implementing an inference agent within the RAG system that processes user queries, wherein the inference agent performs:
converting a user query into a semantic vector;
retrieving from the input documents text segments relevant to the user query based on vector similarity search from the vector database; and
generating responses using a large language model based on the user query and the retrieved text segments.

14. The method of claim 13, wherein the inference agent further performs:
keyword-based searching in parallel with the semantic vector similarity search; and
ranking all retrieved text segments in order of their relevancy to the user query.

15. An apparatus for constructing artificial intelligence (AI) agent workflows, comprising:
a memory for storing instructions;
a processor coupled to the memory, configured by the instructions to:
orchestrate an event-driven architecture by implementing an event broker that provides a message-queuing mechanism;
build an agentic workflow using a plurality of service-flow units (SFUs), each SFU comprising an event handler, a flow controller, and a service comprising a large language model, a software tool, a database, or an AI agent;
configure each event handler to act as both an event producer and an event consumer that interacts directly with the event broker;
implement each flow controller to provide local flow direction from a current SFU to a subsequent SFU within the agentic workflow; and
isolate each service to operate independently from other services in the agentic workflow.

16. A non-transitory computer-readable storage medium storing instructions that, when executed by a processor, cause the processor to:
orchestrate an event-driven architecture by implementing an event broker that provides a message-queuing mechanism;
build an agentic workflow using a plurality of service-flow units (SFUs), wherein each SFU comprises an event handler, a flow controller, and a service comprising a large language model, a software tool, a database, or an AI agent;
configure each event handler to act as both an event producer and an event consumer that interacts directly with the event broker;
implement each flow controller to provide local flow direction from a current SFU to a subsequent SFU within the agentic workflow; and
isolate each service to operate independently from other services in the agentic workflow.
